(19) United States
(12) Patent Application Publication
(10) Pub. No.: US 2025/0063590 A1
(43) Pub. Date: Feb. 20, 2025

(54) OPTIMIZING CHANNEL ACCESS FOR IMPROVED LATENCE IN WI-FI

(71) Applicant: Cisco Technology Inc., San Jose, CA (US)

(72) Inventors: Brian Donald Hart, Sunnyvale, CA (US); Matthew A. Silverman, Shaker Heights, OH (US); Malcolm Smith, Richardson, TX (US)

(21) Appl. No.: 18/449,560

(22) Filed: Aug. 14, 2023

(51) Int. Cl. H04W 72/543; H04W 72/044; H04W 72/566

(52) U.S. Cl. CPC H04W 72/543; H04W 72/044; H04W 72/566; H04W 84/12

(57) ABSTRACT

The present disclosure is directed to determining a first radio as a downlink for transmitting data frames from a first wireless endpoint device to second wireless endpoint devices, determining a second radio as an uplink for transmitting data frames from the second wireless endpoint devices to the first wireless endpoint device, enabling transmissions of data frames from the second wireless endpoint devices to the first wireless endpoint device on the uplink, detecting a first data frame with a latency requirement to be transmitted from the first wireless endpoint device to a targeted second wireless endpoint device, replacing any data frame not associated with a latency requirement in an aggregated MAC protocol data unit with the first data frame, and transmitting the first data frame to the targeted second wireless endpoint device on the downlink.

### TECHNICAL FIELD

The present disclosure generally relates to Wi-Fi technologies, and more specifically to systems and methods for improving latency of transmitting high-priority data packets.

### BACKGROUND

Wi-Fi is a family of wireless network protocols based on the IEEE 802.11 family of standards, which are commonly used for local area networking of devices and Internet access, allowing nearby digital devices to exchange data by radio waves. These are the most widely used computer networks in the world, used globally in home and small office networks to link devices together and to a wireless router to connect them to the Internet, and in wireless access points in public places like coffee shops, hotels, libraries, and airports to provide visitors with Internet connectivity for their mobile devices.

Low latency is a target in Wi-Fi technologies. The low latency requirements vary by applications. They are higher for applications with low-throughput requirements than they are for applications with higher-throughput requirements. In general, latency is a function of the proper network design. Radio latency must be considered alongside end-to-end IP latency and the round-trip delay.

### BRIEF DESCRIPTION OF THE DRAWINGS

FIG. 1 illustrates an example system for enabling communications between an access point and multiple stations, in accordance with certain embodiments;

FIG. 2 illustrates an example system for improving latency of data transmissions between an access point and a station, in accordance with certain embodiments;

FIG. 3 illustrates an example flow diagram of a method for improving latency of data transmissions, in accordance with certain embodiments; and

FIG. 4 illustrates an example computer system, in accordance with certain embodiments.

### DESCRIPTION OF EXAMPLE EMBODIMENTS

### Overview

According to an embodiment, a system may include one or more processors and one or more computer-readable non-transitory storage media comprising instructions that, when executed by the one or more processors, cause one or more components of the system to perform operations including determining, by a first wireless endpoint device, a first radio in a wireless network as a downlink configured for transmitting data frames from the first wireless endpoint device to one or more second wireless endpoint devices; determining, by the first wireless endpoint device, a second radio in the wireless network as an uplink configured for transmitting data frames from the one or more second wireless endpoint devices to the first wireless endpoint device; enabling, such as via continually triggering. UORA, or CSMA/CA, by the first wireless endpoint device, transmissions of a plurality of data frames from the one or more second wireless endpoint devices to the first wireless endpoint device on the uplink; detecting, by the first wireless endpoint device, a first data frame associated with a latency requirement to be transmitted from the first wireless endpoint device to a targeted second wireless endpoint device of the one or more second wireless endpoint devices; replacing, by the first wireless endpoint device, any one of one or more data frames not associated with a latency requirement (or with a lower priority or not subject to as urgent a latency requirement) in an aggregated MAC protocol data unit (AMPDU) with the first data frame; and transmitting, by the first wireless endpoint device, the first data frame in the AMPDU to the targeted second wireless endpoint device on the downlink.

Moreover, the first radio may be at a first carrier frequency and the second radio may be at a second carrier frequency.

Moreover, each of the plurality of data frames transmitted from the one or more second wireless endpoint devices to the first wireless endpoint device on the uplink may be sent in one or more short physical-layer protocol data units (PPDUs).

Additionally, the operations may include determining, by the first wireless endpoint device, that the latency requirement associated with the first data frame has a probability of failing.

Additionally, the operations may include un-scheduling, by the first wireless endpoint device, transmissions of data frames from the one or more second wireless endpoint devices to the first wireless endpoint device on the uplink.

Additionally, the operations may include estimating, by the first wireless endpoint device, an uplink/downlink ratio; and determining, based on the estimated uplink/downlink ratio by the first wireless endpoint device, a first width for a first channel allocated for the first radio and a second width for a second channel allocated for the second radio.

Additionally, the operations may include estimating, by the first wireless endpoint device, an uplink/downlink ratio; and determining, based on the estimated uplink/downlink ratio by the first wireless endpoint device, a first number of subchannels allocated for the first radio and a second number of subchannels allocated for the second radio.

Moreover, the first data frame may be associated with a first priority, and each of the one or more data frames not associated with a latency requirement may be associated with a respective second priority, and the first priority may be higher than the respective second priority.

According to another embodiment, a method may include the steps of determining, by a first wireless endpoint device, a first radio in a wireless network as a downlink configured for transmitting data frames from the first wireless endpoint device to one or more second wireless endpoint devices, determining, by the first wireless endpoint device, a second radio in the wireless network as an uplink configured for transmitting data frames from the one or more second wireless endpoint devices to the first wireless endpoint device, enabling, such as via continually triggering, UORA, or CSMA/CA, by the first wireless endpoint device, transmissions of a plurality of data frames from the one or more second wireless endpoint devices to the first wireless endpoint device on the uplink, detecting, by the first wireless endpoint device, a first data frame associated with a latency requirement to be transmitted from the first wireless endpoint device to a targeted second wireless endpoint device of the one or more second wireless endpoint devices, replacing, by the first wireless endpoint device, any one of one or more data frames not associated with a latency requirement (or with a lower priority or not subject to as urgent a latency requirement) in an aggregated MAC protocol data unit (AMPDU) with the first data frame, and transmitting, by the first wireless endpoint device, the first data frame in the AMPDU to the targeted second wireless endpoint device on the downlink.

According to yet another embodiment, one or more computer-readable non-transitory storage media may embody instructions that, when executed by a processor, cause the performance of operations, including determining, by a first wireless endpoint device, a first radio in a wireless network as a downlink configured for transmitting data frames from the first wireless endpoint device to one or more second wireless endpoint devices, determining, by the first wireless endpoint device, a second radio in the wireless network as an uplink configured for transmitting data frames from the one or more second wireless endpoint devices to the first wireless endpoint device, enabling, such as via continually triggering, UORA, or CSMA/CA, by the first wireless endpoint device, transmissions of a plurality of data frames from the one or more second wireless endpoint devices to the first wireless endpoint device on the uplink, detecting, by the first wireless endpoint device, a first data frame associated with a latency requirement to be transmitted from the first wireless endpoint device to a targeted second wireless endpoint device of the one or more second wireless endpoint devices, replacing, by the first wireless endpoint device, any one of one or more data frames not associated with a latency requirement (or with a lower priority or not subject to as urgent a latency requirement) in an aggregated MAC protocol data unit (AMPDU) with the first data frame, and transmitting, by the first wireless endpoint device, the first data frame in the AMPDU to the targeted second wireless endpoint device on the downlink.

Technical advantages of certain embodiments of this disclosure may include one or more of the following. The systems and methods described herein may get a high-priority data frame onto the wireless medium within a short period of time and guarantee that the high-priority data frame is received by its intended recipient even if the recipient is transmitting on that channel at the same time. The systems and methods described herein may also enable uplink and downlink true SIMPLEX modes, which can be a profound technical advantage to from the point of view of radio-frequency design. Furthermore, the systems and methods described herein may also enable uplink and downlink pseudo-SIMPLEXT modes, allowing RTS/CTS/ACK/BA on both links and even bidirectional management exchanges on link (Probe Request and Response; (Re)Association Request and (Re)Association Response, etc.)

Other technical advantages will be readily apparent to one skilled in the art from the following figures, descriptions, and claims. Moreover, while specific advantages have been enumerated above, various embodiments may include all, some, or none of the enumerated advantages.

### EXAMPLE EMBODIMENTS

In the 802.11 bn amendment which is expected to be marketed as Wi-Fi8, it may be necessary to target better latency to improve reliability of applications. For this purpose, preemption (i.e., getting a protocol data unit with higher priority onto the medium) may be required in the case where a latency requirement is in danger of not being met. However, good mechanisms do not exist in IEEE 802.11 for preemption. In certain cases, good preemption may include the following factors. At any time, any station or access point can decide it has a vital frame to transmit and can get the frame onto the medium within a short period of time for its transmission to be received by its intended recipient. Particularly, having the intended recipient receive the vital frame may raise the stakes because that recipient cannot transmit on that channel at that time.

The embodiments disclosed herein address the aforementioned need for good preemption solutions in Wi-Fi networks to improve latency. In particular embodiments, a radio may be dedicated to a downlink and another radio may be dedicated to an uplink for data. Both links might carry bidirectional control frames (or not). At least one link might carry bidirectional management traffic. As an example and not by way of limitation, such dedication may be achieved based on Multi-Link Operation (MLO) mode such as simultaneous transmit and receive (STR) or via a designation of subchannels (e.g., downlink P20 and uplink S20). In particular embodiments, an access point may be (more or less) continually triggering short physical-layer protocol data units (PPDUs) from the stations on the uplink. The access point may be transmitting short PPDUs on the downlink as needed. Then the access point or station may preempt itself at any time by replacing any frame in the aggregated MAC protocol data unit (AMPDU) by the preempting frame (i.e., sub-PPDU preemption latency).

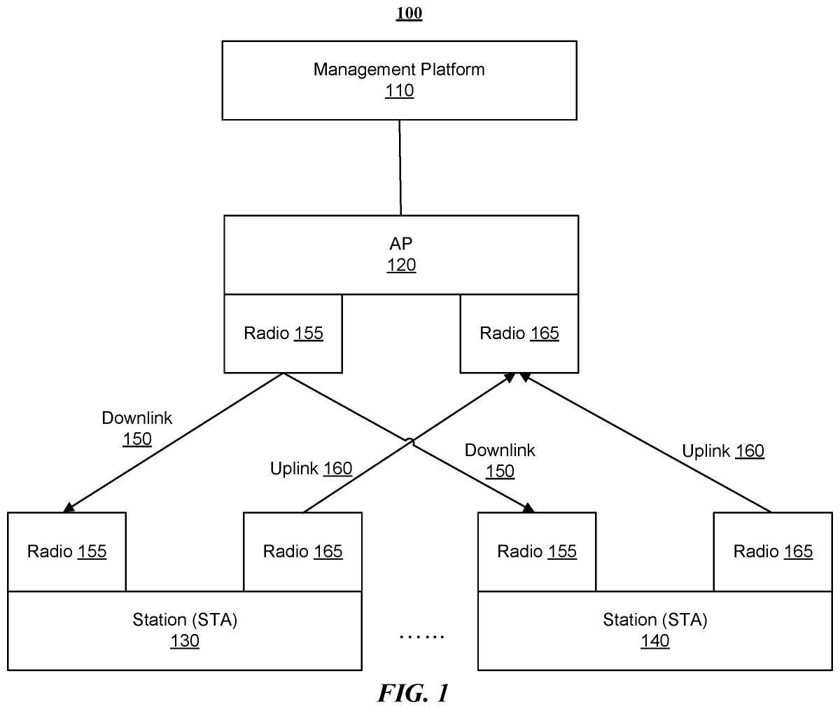

FIG. 1 illustrates an example system 100 for enabling communications between an access point and multiple stations, in accordance with certain embodiments. System 100 may include a management platform 110. As an example and not by way of limitation, the management platform 110 may perform radio resource management, which is the system level management of co-channel interference, radio resources, and other radio transmission characteristics in wireless communication systems, e.g., Wi-Fi networks. In particular embodiments, the management platform 110 may perform radio resource management for a Wi-Fi access point (AP) 120 in a Wi-Fi network. The Wi-Fi network may be based on an Institute of Electrical and Electronic Engineers (IEEE) 802.11 specification.

In particular embodiments, AP 120 may be in communication with a plurality of stations (e.g., STA 130 and STA 140) in the Wi-Fi network. In particular embodiments, AP 120 may be a device that creates a wireless local area network. AP 120 may connect to a wired router, switch, or hub via an Ethernet cable, and transmit a Wi-Fi signal to a designated area to connect other wireless devices, e.g., STA 130 and STA 140. In other words, an access point may relay data between the wireless devices and wired devices of the network. In particular embodiments, STA 130 or STA 140 may be a device that has Wi-Fi capability and allows transmission and reception of data via the wireless local area network.

Examples of an access point (e.g., AP 120) may include a femtocell, a hotspot, a picocell, a small cell, a Wi-Fi array, or any other suitable access device, which may be capable of providing suitable connectivity to a wireless device. Examples of a station (e.g., STA 130 or STA 140), which may also be referred to as “user equipment,” “endpoint,” or “wireless device”, may include a computer, a personal digital assistant (PDA), a laptop, an electronic notebook, a smartphone, an Internet-of-Things (IoT) device, or any other device, component, element, or object capable of sending or receiving data (e.g., voice, audio, video, media) within system 100.

In particular embodiments, AP 120 may provide a communication interface between a station (e.g., STA 130 and STA 140) and the network. More generally, any station may be capable of communicating with any access point, provided that the station is within the coverage area and authorized to communicate with a given access point. In particular embodiments, each of STA 130 and STA 140 may be connected to AP 120 (i.e., may have a respectively established communication link with AP 120) at all times. Communication between an access point and a station may include downlink and/or uplink communications via a wireless communication channel. For downlink communications, AP 120 may act as a transmitter and STA 130 or STA 140 may act as a receiver. For uplink communications, AP 120 may act as a receiver and STA 130 or STA 140 may act as a transmitter. Both uplink and downlink may transmit and receive control frames. At least one link may transmit and receive management frames.

In particular embodiments, the management platform 110 may dedicate a downlink 150 between AP 120 and STA 130, and between AP 120 and STA 140. The management platform 110 may also dedicate an uplink 160 between AP 120 and STA 130, and between AP 120 and STA 140. The downlink 150 may be using a first radio (radio 155) based on a first channel with a first bandwidth. As an example and not by way of limitation, the first channel may have the first bandwidth of 160 MHz configured in the 5 GHz band. The uplink 160 may be using a second radio (radio 165) based on a second channel with a second bandwidth. In particular embodiments, the management platform 110 may communicate the transmission policies to AP 120. As an example and not by way of limitation, the policies may comprise a mapping from a downlink to one or more stations so AP 120 knows a data frame may be transmitted to the stations on such downlink.

In particular embodiments, AP 120 may simultaneously transmit data frames to STA 130 and STA 140 using the downlink (e.g., at 6 GHZ) and receive data frames from STA 130 and STA 140 using the uplink (e.g., at 5 GHZ) as long as there is enough frequency separation. Therefore, if one of the stations has a critical data frame to transmit, they may swap out one of the non-critical or less critical frames they are transmitting with the critical data frame.

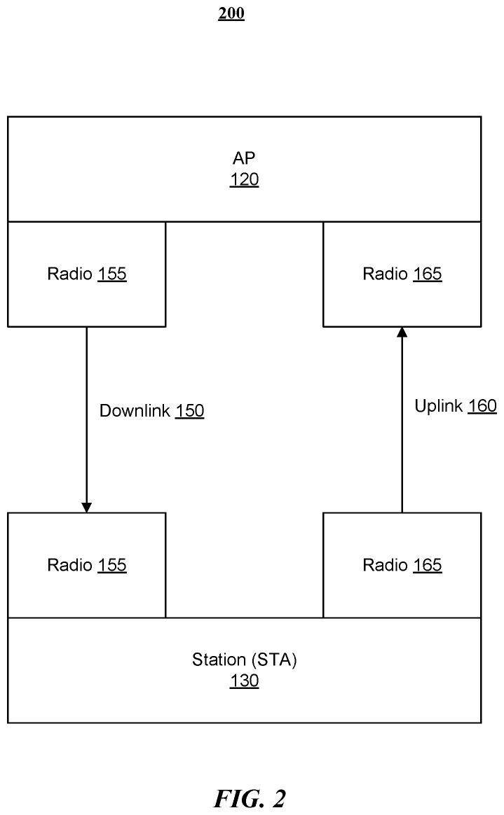

FIG. 2 illustrates an example architecture 200 for using an uplink and a downlink for enabling Wi-Fi preemption, in accordance with certain embodiments. Radio 155 may be designated only for the downlink 150 and radio 165 may be designated only for the uplink 160. STA 130 may only receive data frames on downlink 150 but not transmit data frames using the same downlink 150. Vice versa, STA 130 may only transmit data frames on uplink 160 but not receive data frames using the same uplink 160. AP 120 may continually trigger short PPDUs from STA 130 on the uplink 160.

In particular embodiments, the arrows of downlink 150 and uplink 160 may reflect data frames only. Control frames (very short frames such as RTS, CTS, Trigger, ACK, BA or CF-End) associated with the data frames may be sent on the same link immediately before or after the data frames. In some embodiments, the arrows of downlink 150 and uplink 160 may reflect the direction of data frames and control frames to a larger or complete extent: the acknowledgement (ACK)/block-acknowledgement (BA) event, the RTS frames and trigger frames may be sent on the opposite link. In particular embodiments, management frames may also be transmitted between AP 120 and STA 130. As an example and not by way of limitation, the management frames may comprise beacons, probe requests, probe responses, (Re)Association Requests and (Re)Association responses. The beacons may be on both downlink 150 and uplink 160; or only on the uplink 160; or only on the downlink 150. Management frames may be confined to the same channel that Beacon frames are transmitted on. The probes may be out of band or disallowed. In particular embodiments, the only bidirectional control exchange allowed on the same link may be the request-to-send (RTS) (including MU-RTS) and clear-to-send (CTS) (e.g., either downlink 150 or uplink 160). RTS on the same link may be triggered as to-be-determined (TBD). ACK/BA may be sent on the opposite link.

The uplink 160 may be inefficient if STA 130 does not have much data to send. The downlink 150 may be inefficient in the sense the system may not want any other devices to transmit data on the downlink 150 in case AP 120 has a preempting frame it needs to transmit as soon as possible. To address such issue, the relative uplink/downlink ratio may be estimated. As an example and not by way of limitation, STA 130 may estimate the uplink/downlink ratio via buffer-status-report (BSR). As another example and not by way of limitation, AP 120 may estimate the uplink/downlink ratio via queue depth observation. In particular embodiments, AP 120 may then allocate the subchannels and/or regular channel widths for the downlink 150 and uplink 160 accordingly. As an example and not by way of limitation, the allocation may be based on dynamic bandwidth selection (DBS). In particular embodiments, AP 120 may estimate an uplink/downlink ratio based on a status report from STA 130. In alternative embodiments, AP 120 may estimate the uplink traffic and downlink traffic, respectively. Based on the estimated traffic, the management platform 110 may allocate sectional channel widths for the downlink 150 and uplink 160. In some embodiments, the management platform 110 may allocate a number of subchannels for the downlink 150 and uplink 160.

In particular embodiments, as an additional optimization to reduce latency, after receiving data from AP 120 on the downlink 150, STA 130 may send an ACK/BA frame on the uplink 160 even though the STA 130 did not send any data frame on the uplink 160. In particular embodiments, to implement such optimization, one may build frequency-division duplexing (FDD) on top of the Wi-Fi7 MLO mechanism. Frequency-division duplexing (FDD) is a method for establishing a full-duplex communications link that uses two different radio frequencies for transmitter and receiver operation. FDD operation normally assigns the transmitter and receiver to different communication channels. The embodiments disclosed herein disclose a modified version of FDD where data frames are subject to FDD; and most or all control frames might also be subject to FDD too or be subject to typical 802.11 half-duplex operation. In particular embodiments, the Wi-Fi7 MLO mechanism may handle BA frames from either link. This may enable uplink and downlink pseudo-SIMPLEX or true SIMPLEX modes. In particular embodiments, the technical advantage to simplex may exist from the point of view of radio-frequency design. Building on the additional optimization described above, the uplink 160 may be unscheduled (no AP triggers to collect), thereby resulting in the SIMPLEX mode from the point of view of 802.11 standards since a strong use case for this mechanism can be 802.1Qbv where the endpoint STA 130 controls link access above the MAC, e.g., MAC service data unit (MSDU) shaping.

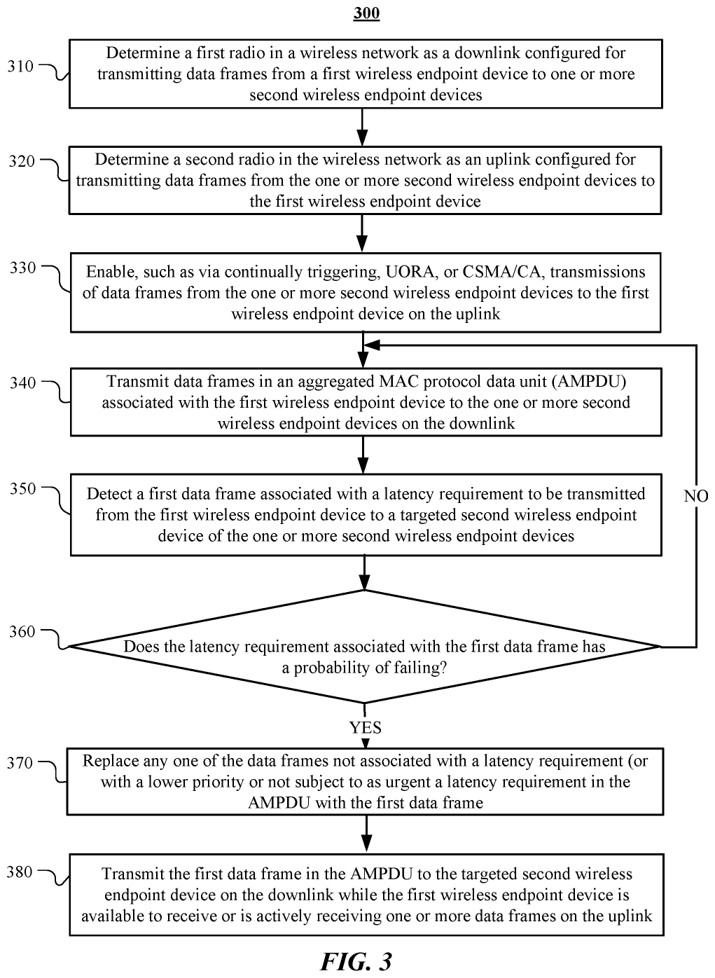

FIG. 3 illustrates an example flow diagram of a method for Wi-Fi preemption, in accordance with certain embodiments. In an embodiment, the steps of method 300 may be performed by a first wireless endpoint device. As an example and not by way of limitation, the first wireless endpoint device may be an access point 120. As another example and not by way of limitation, the first wireless endpoint device may be a station 130. At step 310, the first wireless endpoint device may determine a first radio in a wireless network as a downlink configured for transmitting data frames from a first wireless endpoint device to one or more second wireless endpoint devices.

At step 320, the first wireless endpoint device may determine a second radio in the wireless network as an uplink configured for transmitting data frames from the one or more second wireless endpoint devices to the first wireless endpoint device.

At step 330, the first wireless endpoint device may enable, such as via continually triggering, UORA, or CSMA/CA, transmissions of data frames from the one or more second wireless endpoint devices to the first wireless endpoint device on the uplink.

At step 340, the first wireless endpoint device may transmit data frames in an aggregated MAC protocol data unit (AMPDU) associated with the first wireless endpoint device to the one or more second wireless endpoint devices on the downlink.

At step 350, the first wireless endpoint device may detect a first data frame associated with a latency requirement to be transmitted from the first wireless endpoint device to a targeted second wireless endpoint device of the one or more second wireless endpoint devices.

At step 360, the first wireless endpoint device may determine whether the latency requirement associated with the first data frame has a probability of failing. If the first data frame does not have a probability of failing, the method 300 may return to step 340. If the first data frame has a probability of failing, the method 300 may proceed to step 370.

At step 370, the first wireless endpoint device may replace any one of the data frames not associated with a latency requirement (or with a lower priority or not subject to as urgent a latency requirement) in the AMPDU with the first data frame. At step 380, the first wireless endpoint device may transmit the first data frame in the AMPDU to the targeted second wireless endpoint device on the downlink while the first wireless endpoint device is available to receive or is actively receiving one or more data frames on the uplink.

It is to be understood that one or more steps of method 300 may be executed by a wireless endpoint device. In other embodiments, the method may be executed by one or more components of a system, such as system 100 described in FIG. 1. In still other embodiments, the method 300 of FIG. 3 may be construed in view of the described systems and processes of FIGS. 1-2.

It is to be understood that the order in which the method 300 is described is not intended to be construed as a limitation, and any number of the described method steps may be combined, modified, or carried out in any order to implement the method 300 or alternative methods. Additionally, individual steps may be deleted from the method 300 without departing from the spirit and scope of the subject matter described herein. Furthermore, the method 300 can be implemented in any suitable hardware, software, firmware, or combination thereof.

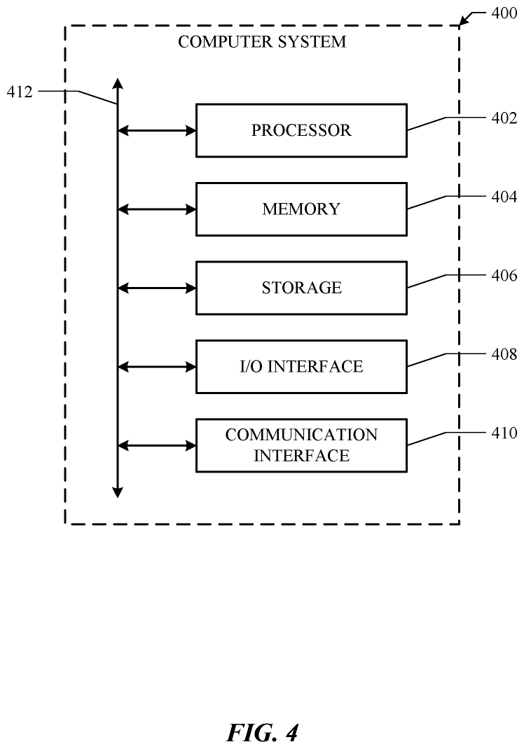

FIG. 4 illustrates an example computer system 400, in accordance with certain embodiments. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network, a Long-Term Evolution (LTE) network, or a 5G network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

The embodiments disclosed herein are only examples, and the scope of this disclosure is not limited to them. Particular embodiments may include all, some, or none of the components, elements, features, functions, operations, or steps of the embodiments disclosed herein. Embodiments according to the disclosure are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

What is claimed is:

1. A system, comprising:
one or more processors; and
one or more computer-readable non-transitory storage media comprising instructions that, when executed by the one or more processors, cause one or more components of the system to perform operations comprising:
determining, by a first wireless endpoint device, a first radio in a wireless network as a downlink configured for transmitting data frames from the first wireless endpoint device to one or more second wireless endpoint devices;
determining, by the first wireless endpoint device, a second radio in the wireless network as an uplink configured for transmitting data frames from the one or more second wireless endpoint devices to the first wireless endpoint device;
enabling, by the first wireless endpoint device, transmissions of a plurality of data frames from the one or more second wireless endpoint devices to the first wireless endpoint device on the uplink;
detecting, by the first wireless endpoint device, a first data frame associated with a latency requirement to be transmitted from the first wireless endpoint device to a targeted second wireless endpoint device of the one or more second wireless endpoint devices;
replacing, by the first wireless endpoint device, any one of one or more data frames not associated with a latency requirement in an aggregated MAC protocol data unit (AMPDU) with the first data frame; and
transmitting, by the first wireless endpoint device, the first data frame in the AMPDU to the targeted second wireless endpoint device on the downlink.

2. The system of claim 1, wherein the first radio is at a first carrier frequency, and wherein the second radio is at a second carrier frequency.

3. The system of claim 1, wherein each of the plurality of data frames transmitted from the one or more second wireless endpoint devices to the first wireless endpoint device on the uplink is sent in one or more short physical-layer protocol data units (PPDUs).

4. The system of claim 1, wherein the operations further comprise:
determining, by the first wireless endpoint device, that the latency requirement associated with the first data frame has a probability of failing.

5. The system of claim 1, wherein the operations further comprise:
un-scheduling, by the first wireless endpoint device, transmissions of data frames from the one or more second wireless endpoint devices to the first wireless endpoint device on the uplink.

6. The system of claim 1, wherein the operations further comprise:
estimating, by the first wireless endpoint device, an uplink/downlink ratio; and
determining, based on the estimated uplink/downlink ratio by the first wireless endpoint device, a first width for a first channel allocated for the first radio and a second width for a second channel allocated for the second radio.

7. The system of claim 1, wherein the operations further comprise:
estimating, by the first wireless endpoint device, an uplink/downlink ratio; and
determining, based on the estimated uplink/downlink ratio by the first wireless endpoint device, a first number of subchannels allocated for the first radio and a second number of subchannels allocated for the second radio.

8. The system of claim 1, wherein the first data frame is associated with a first priority, wherein each of the one or more data frames not associated with a latency requirement is associated with a respective second priority, and wherein the first priority is higher than the respective second priority.

9. A method, comprising:
determining, by a first wireless endpoint device, a first radio in a wireless network as a downlink configured for transmitting data frames from the first wireless endpoint device to one or more second wireless endpoint devices;
determining, by the first wireless endpoint device, a second radio in the wireless network as an uplink configured for transmitting data frames from the one or more second wireless endpoint devices to the first wireless endpoint device;
enabling, by the first wireless endpoint device, transmissions of a plurality of data frames from the one or more second wireless endpoint devices to the first wireless endpoint device on the uplink;
detecting, by the first wireless endpoint device, a first data frame associated with a latency requirement to be transmitted from the first wireless endpoint device to a targeted second wireless endpoint device of the one or more second wireless endpoint devices;
replacing, by the first wireless endpoint device, any one of one or more data frames not associated with a latency requirement in an aggregated MAC protocol data unit (AMPDU) with the first data frame; and
transmitting, by the first wireless endpoint device, the first data frame in the AMPDU to the targeted second wireless endpoint device on the downlink.

10. The method of claim 9, wherein the first radio is at a first carrier frequency, and wherein the second radio is at a second carrier frequency.

11. The method of claim 9, wherein each of the plurality of data frames transmitted from the one or more second wireless endpoint devices to the first wireless endpoint device on the uplink is sent in one or more short physical-layer protocol data units (PPDUs).

12. The method of claim 9, further comprising:
determining, by the first wireless endpoint device, that the latency requirement associated with the first data frame has a probability of failing.

13. The method of claim 9, further comprising:
un-scheduling, by the first wireless endpoint device, transmissions of data frames from the one or more second wireless endpoint devices to the first wireless endpoint device on the uplink.

14. The method of claim 9, further comprising:
estimating, by the first wireless endpoint device, an uplink/downlink ratio; and
determining, based on the estimated uplink/downlink ratio by the first wireless endpoint device, a first width for a first channel allocated for the first radio and a second width for a second channel allocated for the second radio.

15. The method of claim 9, further comprising:
estimating, by the first wireless endpoint device, an uplink/downlink ratio; and
determining, based on the estimated uplink/downlink ratio by the first wireless endpoint device, a first number of subchannels allocated for the first radio and a second number of subchannels allocated for the second radio.

16. The method of claim 9, wherein the first data frame is associated with a first priority, wherein each of the one or more data frames not associated with a latency requirement is associated with a respective second priority, and wherein the first priority is higher than the respective second priority.

17. A non-transitory computer-readable medium comprising instructions that are configured, when executed by a processor, to:
determine, by a first wireless endpoint device, a first radio in a wireless network as a downlink configured for transmitting data frames from the first wireless endpoint device to one or more second wireless endpoint devices;
determine, by the first wireless endpoint device, a second radio in the wireless network as an uplink configured for transmitting data frames from the one or more second wireless endpoint devices to the first wireless endpoint device;
enable, by the first wireless endpoint device, transmissions of a plurality of data frames from the one or more second wireless endpoint devices to the first wireless endpoint device on the uplink;
detect, by the first wireless endpoint device, a first data frame associated with a latency requirement to be transmitted from the first wireless endpoint device to a targeted second wireless endpoint device of the one or more second wireless endpoint devices;
replace, by the first wireless endpoint device, any one of one or more data frames not associated with a latency requirement in an aggregated MAC protocol data unit (AMPDU) with the first data frame; and
transmit, by the first wireless endpoint device, the first data frame in the AMPDU to the targeted second wireless endpoint device on the downlink.

18. The non-transitory computer-readable medium of claim 17, wherein the first radio is at a first carrier frequency, and wherein the second radio is at a second carrier frequency.

19. The non-transitory computer-readable medium of claim 17, further comprising instructions that are configured, when executed by a processor, to:
estimate, by the first wireless endpoint device, an uplink/downlink ratio; and
determine, based on the estimated uplink/downlink ratio by the first wireless endpoint device, a first width for a first channel allocated for the first radio and a second width for a second channel allocated for the second radio.

20. The non-transitory computer-readable medium of claim 17, further comprising instructions that are configured, when executed by a processor, to:
estimate, by the first wireless endpoint device, an uplink/downlink ratio; and
determine, based on the estimated uplink/downlink ratio by the first wireless endpoint device, a first number of subchannels allocated for the first radio and a second number of subchannels allocated for the second radio.
